(19) United States
(12) Patent Application Publication
(10) Pub. No.: US 2007/0254985 A1
(43) Pub. Date: Nov. 1, 2007

(54) Resin dispersions with low surfactant concentrations

(76) Inventors: Joost Hubert Maas, Helmond (NL); Peter James Miller, Gray, TN (US)

Correspondence Address: Tammye L. Taylor;Eastman Chemical Company, P.O. Box 511, Kingsport, TN, 37662-5075, US

(21) Appl. No.: 11/787,837

(22) Filed: Apr. 18, 2007

Related U.S. Application Data
(60) Provisional application No. 60/793,796, filed on Apr. 21, 2006.

(51) Int. Cl. C08J 3/00

(52) U.S. Cl. 523/336

(57) ABSTRACT

The invention is a process for removing excess surfactant from a resin dispersion. The excess surfactant is initially required to form the dispersion, but it is not needed to maintain the stability of the dispersion. The process involves the addition of an acid to a dispersion. The acid reacts with one of the surfactants, and the acidified surfactant returns to its original non-neutralized form or its original hydrophobic form and no longer has the structural capacity to serve as a surfactant. The reduction of the surfactant concentration in the dispersions improves the cohesive strength of adhesives made with the dispersions.

This application claims benefit of provisional application entitled, RESIN DISPERSIONS WITH LOW SURFACTANT CONCENTRATIONS, Ser. No. 60/793,796, filed Apr. 21, 2006, incorporated by reference herein.

### FIELD OF THE INVENTION

The present invention generally pertains to the field of resin dispersions and to the preparation of adhesives therewith.

### BACKGROUND OF THE INVENTION

Many types of adhesive formulations, especially pressure sensitive adhesives based on synthetic polymers such as acrylic polymers and styrenic block-co-polymers, usually need some kind of tackifier in the formulation. The tackifier improves the adhesive properties such as tackiness, peel-resistance and the ease of surface wetting. The tack of an adhesive enables it to form an immediate bond between contacted surfaces when they are brought together.

Tackifiers are generally based on resins, tackifier resins, which can be considered as high viscosity solvents for a base polymer in a formulation. A tackifier should be seen as a material which relates to a specific material or group of materials that it tackifies.

Various resinous materials have been suggested as tackifier resins for synthetic polymers. Examples of suggested materials include rosin, disproportionated rosin, rosin esters such as triethylene glycol esters of rosin, glycerol esters of rosin and pentaerythritol esters of rosin, aliphatic hydrocarbon resins, aromatic petroleum resins, DCPD resins, terpene resins, terpene/phenol resins and cumarone/indene resins.

Tackifier resins for pressure sensitive adhesives are usually based on rosin and/or derivatives thereof or hydrocarbon resins. Rosin is a natural resinous product mainly consisting of rosin acids. Typical rosin acids are, for example, abietic acid and levopimaric acid. The difference between the rosin acids is mainly the number and position of the double bonds. Rosin may be classified based on the species of the tree from which it originates such as Chinese, Indonesian, and Brazilian rosin and/or to the production process from which it originates such as gum rosin, wood rosin or tall oil rosin.

Hydrocarbon resins are generally low-molecular weight aliphatic or aromatic polymers typically having a weight average molecular weight of 500-3000. Typically, these resins originate from the oil or natural gas cracking industry.

In aqueous adhesive compositions it is common to include the tackifier resin in the form of an aqueous dispersion. In order to make a dispersion from resinous material such as rosin or hydrocarbon resin, a surfactant is needed to act as an emulsifier. In the case of rosin and hydrocarbon resins, the aqueous dispersion is usually made by first melting the rosin or hydrocarbon resin and then adding a surfactant and water to form a dispersion in which the rosin/resin is the dispersed phase and water the continuous phase.

The resulting tackifier resin dispersions are then combined with the polymers to make the adhesive formulations. The resin dispersions used to make the adhesive may impact the adhesive properties of the resulting formulation. In particular, the surfactant used in the dispersion may have an effect on the adhesive properties of the resulting formulation. Adhesion is a surface phenomenon and therefore may be affected by the choice and amount of surfactant present in the adhesive formulation. Generally, surfactants have a tendency to migrate to the interface between air and adhesive. Therefore, surfactants may change the surface properties and adhesion energy of the adhesive. Typically, in adhesive compositions excess surfactant in the tackifier dispersion may result in a loss of cohesive strength.

Thus, there remains a need in the art to provide tackifier resin dispersions with lower surfactant concentrations so that the cohesive strengths of adhesive formulations produced using the dispersions are not affected or even improved.

### BRIEF SUMMARY OF THE INVENTION

The present invention relates to a process for producing tackifier resin dispersions comprising: melting a resin; contacting the resin with a surfactant system comprising two or more surfactants; neutralizing at least one surfactant with at least one neutralizing agent; adding water to invert the dispersion; and adding an acid to react with at least one of the surfactants.

The present invention also relates to a process for producing resin dispersions comprising: melting a resin; contacting the resin with at least one surfactant, wherein at least one surfactant is added in excess; neutralizing at least one surfactant with at least one neutralizing agent; adding water to invert the dispersion; and adding an acid to react with the excess surfactant.

One aspect of the present inventions pertains to adhesive compositions comprising a tackifier resin dispersion, a polymer latex, and water, wherein the dispersion is prepared by a process comprising dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

An additional aspect of the present invention pertains to adhesive compositions comprising a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess rosin acid no longer migrates into the aqueous phase.

The present invention also pertains to pressure sensitive adhesive overlays prepared by applying a layer of adhesive composition to a surface of a substrate, and drying the layer, wherein the adhesive composition comprises a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess portion of the rosin acid no longer migrates into the aqueous phase.

The present invention also pertains to pressure sensitive adhesive overlays prepared by applying a layer of adhesive composition to a surface of a substrate, and drying the layer, wherein the adhesive composition comprises a tackifier resin dispersion, a polymer latex, and water, wherein the dispersion is prepared by a process comprising-dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

A further aspect of the present invention pertains to the use of the tackifier dispersions, in combination with polymer latexes to prepare adhesives. The adhesives according to the present invention may be employed in the following fields: labels on any kind of surface, packaging applications, flooring adhesives, road markings or any type of water-based tapes, barrier coatings or sealants.

### DETAILED DESCRIPTION OF THE INVENTION

The present invention may be understood more readily by reference to the following detailed description of the invention and to the Examples included therein.

Before the present compositions of matter and methods are disclosed and described, it is to be understood that this invention is not limited to specific synthetic methods or to particular formulations, unless otherwise indicated, and, as such, may vary from the disclosure. It is also to be understood that the terminology used is for the purpose of describing particular embodiments only, and is not intended to limit the scope of the invention.

The singular forms “a”, “an”, and the “the” include plural referents, unless the context clearly dictates otherwise.

Optional or optionally means that the subsequently described events or circumstances may or may not occur. The description includes instances where the events or circumstances occur, and instances where they do not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

Some relevant technical terms as used in the context of the present invention are meant to be understood as follows (unless specifically indicated otherwise throughout the description).

“Surfactants” (a term understood to be synonymous with the term “emulsifier” for the purposes of the present invention) in the meaning of the present invention provide stability and prevent coalescence of particles formed during emulsification. Surfactants furthermore prevent the coagulation or aggregation of particles in the final dispersion. Typically, surfactants are organic compounds that are amphiphilic in nature. Due to their amphiphilic character, surfactant molecules have an affinity for both oil and water phases. As a result, a balance exists between surfactant molecules present at the oil-water interface and molecules present in the oil and water phases. Further, according to the present invention, any compound may be referred to as a “surfactant” if it functions as a surfactant in its neutralized form; for example, a compound whose neutralized salt is amphiphilic in nature may be referred to as a “surfactant”.

“Tackifier” in the meaning of the present invention pertains to any of several compositions useful for imparting tack to adhesive compositions. The terms “tackifier dispersion”, “resin dispersion”, and “tackifier resin dispersion” are used interchangeably.

“Adhesion” (or adhesive properties) in the meaning of the present invention relate(s) to the interaction of the adhesive formulation with the substrate to which it is applied. Characteristically, adhesive forces mainly concern the interface between adhesive and substrate. Suitable tests to measure adhesion are, for example, the “loop tack” test and the “peel strength” test. These tests are described in the FINAT Technical Handbook, 6^{th} edition, 2001. Loop tack is measured according to FINAT Test Method (FTM) 9 (page 22 et seq. of the Handbook). Peel Strength is measured according to FTM 1 (page 6 et seq. of the Handbook).

“Cohesion” (or cohesive properties) in the meaning of the present invention relates to interaction/forces within the adhesive. Typically, cohesive forces mainly concern the bulk phase of the adhesive. A suitable test to measure cohesion is the “shear cohesion” test. Shear Cohesion is measured according to FTM 8 (page 20 et seq. of the Handbook).

A “rosin acid” according to the present invention is understood to comprise a mixture of various rosin acid molecules. Mixtures of this kind that are readily available and occur in nature include, but are not limited to, tall oil rosin, gum rosin or wood rosin. These natural mixtures may comprise rosin acids of the abietic type and/or the pimaric type such as abietic acid, palustric acid, neoabietic acid, levopimaric acid, pimaric acid, isopimaric acid or dehydroabietic acid, among others, in varying amounts. In addition to rosin acids with one carboxylic acid functionality, rosin acids with two or more carboxylic acid functionalities are also considered as rosin acids in the meaning of the present invention.

A “rosin acid derivative” according to the present invention is any molecule that has the molecular rosin acid backbone but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

A “rosin ester” according to the present invention is any molecule in which at least two rosin acid or rosin acid derivative units are connected by means of at least two ester linkages. Any molecule with at least two hydroxyl groups can be used to provide the ester linkages between at least two rosin acids units. Common examples include, but are not limited to, glycerol esters, pentaerythritol esters and (triethylene) glycol esters.

The “solid content” of a tackifier resin dispersion is given in % weight per overall weight of the dispersion (unless indicated otherwise).

“Water-based” tackifier resin dispersions according to the present invention are dispersions of tackifier entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well.

One aspect of the present invention relates to a process for producing resin dispersions. This process involves a surfactant system that provides an excess of surfactant as is generally required to produce a stable dispersion and a method to inactivate the excess surfactant in the resulting dispersion such that the cohesive strength of an adhesive produced using the dispersion is not affected.

Another aspect of the present invention, relates to a process for producing a resin dispersion using a surfactant system that includes two or more surfactants to produce a stable dispersion and at least one of the surfactants is inactivated in the resulting dispersion such that the adhesive characteristics of an adhesive produced using the dispersion is not affected. By inactivating a portion of the surfactant in the resin dispersion, the cohesive strength of the resulting adhesive composition may increase.

One embodiment of the present invention provides a process for producing a resin dispersion by melting a resin; contacting the resin with a surfactant system according to the present invention which includes two or more surfactants; neutralizing at least one of the surfactants in the surfactant system with at least one neutralizing agent; adding water to invert the dispersion; and adding an acid to react with at least one of the surfactants. In one embodiment, the acid reacts with the neutralized surfactant.

Another embodiment of the present invention provides a process for producing a resin dispersion by melting a resin; contacting the resin with the surfactant system according to the present invention which includes at least one surfactant added in excess; neutralizing at least one surfactant with at least one neutralizing agent; adding water to invert the dispersion; and adding an acid to react with the excess surfactant.

According to the present invention, the melting of the resin or the resinous material may be carried out by any conventional method known in the art. For example, in one embodiment, the resin or resinous material is melted at a temperature from about 50° C. to about 200° C. In another embodiment, the resin or resinous material may be heated approximately 10° C. to 30° C. above the softening point of the resin or the mixture of resins.

Generally, the tackifier resins can be characterized by a Ring and Ball softening point ranging from about 40° C. to about 180° C., for example from about 50° C. to about 120° C., or from about 70° C. to about 140° C. Typically, for resins or mixtures of resins with a Ring and Ball softening point of greater than about 100° C., the process is carried out under pressurized conditions.

Any resins or resinous material conventionally used as tackifiers in resin dispersions are suitable for use according to the present invention. Suitably, the tackifier resins can be selected from the group consisting of rosins, rosin derivatives, rosin esters, hydrogenated rosin esters, hydrocarbon resins, aliphatic resins, cycloaliphatic resins, aromatic hydrocarbon resins, mixed aliphatic-aromatic resins, polyterpenes, synthetic polyterpenes, natural terpenes, aromatically modified terpene resins, or mixtures thereof.

These tackifier resins can also have differing degrees of hydrogenation or saturation, and can also be modified by different compounds. Modifiers include, but are not limited to, homopolymers, copolymers and terpolymers of ethylene, ethylene vinyl acetate, n-butyl acrylate copolymers, ethylene methacrylate copolymers, ethylene acrylic acid copolymers as well as triblock, diblock and multiblock copolymers.

For example, suitable resins include, but are not limited to, (1) natural and modified rosins and the hydrogenated derivatives thereof; (2) esters of natural and modified rosins and the hydrogenated derivatives thereof; (3) polyterpene resins and hydrogenated polyterpene resins; (4) aliphatic petroleum hydrocarbon resins and the hydrogenated derivatives thereof; (5) aromatic hydrocarbon resins and the hydrogenated derivatives thereof; (6) alicyclic petroleum hydrocarbon resins and the hydrogenated derivatives thereof, (7) low molecular weight acrylates and the derivatives thereof, or (8) low molecular weight urethane-acrylates and mixtures thereof. Mixtures of two or more of the above-described resins suitably may be used for some formulations. For example, suitable hydrocarbon resins include aliphatic or aromatic hydrocarbon resins, DCPD resins, terpene resins, terpene/phenol resins or cumarone/indene resins.

In some embodiments of the present invention, the resin or resinous material is a rosin. For example, in some embodiments the rosins may comprise rosin acids. Generally, rosins acids are mixtures of C₂₀ monobasic carboxylic acids containing a phenanthrene skeleton.

Rosins and rosin derivatives include rosin acids obtained from naturally occurring sources such as tall oil rosin, gum rosin, or wood rosin. Fractions or mixtures of these sources may be used as well. The mixtures may be a combination of two or more of the natural products with each other or the natural products may be mixed with purified or synthetically produced rosin acids as well. No limitations exist with respect to the degree of hydrogenation, dehydrogenation or the variation of any of the functional groups that may be attached to the rosin acid as long as the carboxyl-functionality remains intact for at least some of the molecules.

Suitably, in other embodiments, the rosin can be an unmodified or a modified rosin. There are many different ways of modifying rosins. For example, the rosin can be partially fortified or esterified. Suitable rosins include, but are not limited to, rosin acids, rosin esters, hydrogentated rosins, dimerized rosins, modified rosins, and polymerized rosins. Suitably, in some embodiments, the rosin is a glycerol, pentaerythritol or triethylene glycol ester of a rosin acid. Suitably, in other embodiments, any low molecular weight compounds containing multiple hydroxyl groups could be used to produce rosin esters.

Suitably, the rosin may also be treated with paraformaldehyde in the presence of paratoluene sulphonic acid to inhibit crystallization or it can be stabilized by disproportionation which involves transferring hydrogen atoms from one molecule of abietic acid to another. In some embodiments, the rosin may be modified by reacting an unsaturated di-acid such as maleic or furmaric acid to the rosin ester molecule. The tackifier dispersions according to the invention may comprise any of the above described rosins or mixtures thereof.

Examples of suitable rosins and rosin derivatives include, but are not limited to, Foral® AX-E, Foralyn® 90, Dymerex® resin, Polystix® 90 and Permalyn® 3100 available from Eastman Chemical. Other useful examples are Sylvatac® RE 4216 and Sylvatac® RE 85 available from Arizona Chemical.

Aliphatic resins according to the present invention are defined as tackifiers produced from at least one monomer selected from alkanes, alkenes, or alkynes. These monomers can be straight chains or branched. For example, an aliphatic resin can be produced by polymerizing cis- and trans-piperylene, isoprene, or dicyclopentadiene. Examples of aliphatic resins include, but are not limited to, Piccotac® 1095 from Eastman Chemical; Hikorez® C— 10 available from Kolon Industries; and Wingtack® 95 available from Goodyear Chemical. Hydrogenated cycloaliphatic resins include, but are not limited to, Eastotac® H-100, Eastotac® H-115, Eastotac® H-130, and Eastotac®1H-142 available from Eastman Chemical. These tackifier resins have Ring and Ball softening points of 100° C., 115° C., 130° C., and 142° C., respectively. The Eastotac® resins are available in various grades (E, R, L and W) that differ in the level of hydrogenation.

Aromatic hydrocarbon resins according to the present invention are defined as hydrocarbon resins produced from at least one unsaturated cyclic hydrocarbon monomer having one or more rings. For example, aromatic hydrocarbon resins can be produced from polymerizing indene or methylindene with styrene or methylstyrene in the presence of a Lewis acid. Commercial examples of aromatic hydrocarbon resins include, but are not limited to, Kristalex® 3100 and Kristalex® 5140 available from Eastman Chemical. Hydrogenated aromatic resins include, but are not limited to, Regalre® 1094 and Regalrez® 1128 available from Eastman, Chemical.

Aliphatic-aromatic tackifier resins according to the present invention are produced from at least one aliphatic monomer and at least one aromatic monomer. Aliphatic monomers and aromatic monomers were defined previously in this disclosure. Examples of aliphatic-aromatic tackifier resins include, but are not limited to, Piccotace 9095 available from Eastman Chemical and Wingtack® Extra available from Goodyear Chemical. Hydrogenated aliphatic-aromatic resins include, but are not limited to, Regalite® V3100 available from Eastman Chemical and Escorez® 5600 available from Exxon Mobil Chemical.

Polyterpene resins according to the present invention are defined as tackifier resins produced from at least one terpene monomer. For example, alpha.-pinene, .beta.-pinene, d-limonene, and dipentene can be polymerized in the presence of aluminum chloride to provide polyterpene tackifier resins. Other examples of polyterpene tackifier resins include, but are not limited to, Sylvares® TR 1100 available from Arizona Chemical, and Piccolyte® A125 available from Pinova.

Examples of aromatically modified terpene resins include, but are not limited to, Sylvares® ZT 105LT and Sylvares® ZT 115LT available from Arizona Chemical.

Any conventional surfactant or combination of surfactants is suitable for use in the present invention. Suitably, ionic (ie. ionizable) surfactants may be used in some embodiments of the present invention. For example, in one embodiment, the surfactants may be any ionizable organic compounds whose neutralized salts are amphiphilic in nature, such as, for example, any carboxylic acid containing compound, any phosphoric acid containing compound, any sulfuric acid containing compound, any alkyl sulphonates, any fatty alcohol sulphate containing compounds, any sulfonic acid containing compound, any sulfonate succinic acid containing compound, any sulfosuccinic acid containing compound, any sulfosuccinamic acid containing compound, or any disulfosuccinic acid containing compound. For example, in another embodiment, the ionic surfactant may be one or more of the following: a rosin acid, a hydrogenated rosin acid, a disproportionated rosin acid, or a modified rosin acid.

Additionally, by further example, the following surfactants would be suitable for use as ionic surfactants according to the present invention: alkyldiphenyloxide disulfonate, sodium dodecylbenzene sulfonate; neutralized dodecylbenzene sulfonic acid; potassium dodecylbenzene sulfonate; sodium dodecylbenzene sulfonate; ammonium nonylphenol ethoxylate sulfate; sodium nonylphenol ethoxylate sulfate; sodium lauryl ether sulfate; ammonium lauryl ether sulfate; sodium decyl sulfate; sodium lauryl sulfate; sodium octyl sulfate; sodium tridecyl sulfate; sodium tridecyl ether sulfate; potassium oleate sulfonate, sodium dioctyl sulfonate succinate; tristyrylphenol ethoxylate-POE-16 phosphate ester, potassium salt, tristyrylphenol ethoxylate-poe-16 phosphate ester, amine salt; magnesium lauryl sulfate; sodium decyl sulfate; sodium 2-ethyl hexyl sulfate; sodium C14-16 olefin sulfonate; tetrasodium dicarboxyethyl stearyl sulfosuccinamate; sodium alkyl sulfonates; sodium octyl sulfate; alkyl napthalene sulfonate; sodium tridecyl ether sulfate; triethyl ammonium lauryl sulfate; sodium decylglucosides hydroxypropyl sulfonate; sodium decylglucosides hydroxypropyl sulfonate; sodium laurylglucosides hydroxypropyl sulfonate; sodium didecylglucosides hydroxypropyl phosphate; sodium dilaurylglucosides hydroxypropyl phosphate; sodium dibutylglucosides hydroxypropyl phosphate; potassium monoalkyl phosphate; triethanolamine monoalkyl phosphate; sodium dioctyl sulfosuccinate; sodium decyl diphenyl oxide disulfonate; disodium oleamido MEA sulfosuccinate; disodium ricinoleamido MEA sulfosuccinate; ammonium lauryl sulfosuccinate; sodium dodecyl diphenyl oxide disulfonate; sodium ditridecyl sulfosuccinate; sodium laureth sulfate (2 EO); sodium laureth sulfate; ammonium lauryl sulfate; ammonium laureth sulfate; TEA-lauryl sulfate; TEA-laureth sulfate; MEA-lauryl sulfate; MEA-laureth sulfate; potassium lauryl sulfate; potassium laureth sulfate; sodium decyl sulfate; sodium octyl/decyl sulfate; sodium 2-ethylhexyl sulfate; sodium octyl sulfate; α-olefin sulfonate; sodium α-olefin sulfonate; alkyl phonol ether sulfate; sodium nonoxynol-4 sulfate; sodium nonoxynol-6 sulfate; or ammonium nonoxynol-6 sulfate.

Examples of suitable alkyl aryl sulphonates include, but are not limited to, sodium or ammonium alkyl benzene sulphonates, fatty alcohol sulphates, e.g. sodium lauryl sulphate, salts of mono- and di-esters of orthophosphoric acid, sodium salts of sulphated monoglycerides and sulphonates or sulphosuccinates of alkyl phenol polyoxyalkylene oxide condensates or of polyoxyalkylene oxide condensates, e.g. the ammonium salt of nonylphenol polyethylene oxide sulphonic acid.

In one embodiment, the surfactant may be any carboxylic acid containing compound whose neutralized salt is amphiphilic. For example, in one embodiment the surfactant may be a rosin acid. Embodiments using rosin acids in the dispersion are particularly useful in the resulting adhesive formulations because the rosin acid serves a dual function both as a surfactant in its neutralized form during the dispersion inversion process and as a tackifier in its non-neutralized form when the resulting dispersion is incorporated into the adhesive formulation. For example, wood rosins (i.e. neutralized wood rosins) would be suitable for use as a surfactant according to the present invention.

In one embodiment of the present invention, at least one of the surfactants in the inventive surfactant system should be ionic. In another embodiment, the ionic surfactant should also be neutralizable with a suitable counter ion either partially or completely. Any conventional neutralizing agent is suitable for use according to the present invention. Suitably, the neutralizing agent or ionizing agent, may or may not be a readily volatilizable material, such as, for example, ammonium hydroxide, amines, or hydroxylamines, but it may also be any base such as an alkali metal hydroxide or alkaline earth metal hydroxide. For example, suitable neutralizing agents include NaOH, KOH, or NH₄OH. Also, the neutralizing agent may be a mixture of two volatile bases or a mixture of nonvolatile bases.

In one embodiment of the present invention, the surfactant system contains at least one ionic surfactant added in excess. Generally, the excess surfactant is initially required to form the dispersion, but it is not needed to maintain the stability of the dispersion.

In another embodiment of the present invention, the surfactant system contains two or more surfactants with at least one ionic surfactant in combination with at least one other surfactant. The other surfactant can be ionic or nonionic (ie. nonionizable). In embodiments where the other surfactant is ionic or in embodiments where two or more surfactants are ionic, the pKa value of the non-neutralized form of at least one of the surfactants should be sufficiently different than that of the remaining surfactants. Sufficiently different according to the present invention is a difference in pKa values of approximately 0.5 or greater. For example, the pKa value of the non-neutralized form of at least one of the ionic surfactants should be higher than that of the remaining surfactants. In one embodiment, the neutralized form of the ionic surfactant with the higher pKa value may react first with the acid.

Suitably, in one embodiment of the present invention, any conventional nonionic surfactant may be used in combination with the ionic surfactant. According to the present invention, suitable nonionic surfactants include, but are not limited to, any long chain ethyoxylate block copolymers, any hydroxyl terminal long chain ethoxylates, alcohol ethoxylates, alkyl ethoxylates, alkyl phenols, alkyl phenol ethoxylates, alkyl alcohol ethoxylates, alkyl sulphonates, fatty alcohol sulphates, alkyl phenol ethoxylate phosphates, or phosphate esters.

Examples of suitable alkyl phenol ethoxylates include, but are not limited to, nonylphenol ethoxylate phosphates. The term ‘nonylphenol’ represents a large number of isomeric compounds of the general formula HOC₆H₄C₉H₁₉. Commercially produced nonylphenols are predominantly 4-nonylphenol with a varied and undefined degree of branching in the attached alkyl group, alkylsulfonic acid, fatty acid, oxyethylated alkyphenol and derivatives, or mixtures thereof.

Examples of suitable nonionic surfactants include, but are not limited to, esters of sulphosuccinic acid, fatty alkanolamide; oleyl diethanolamide; lauryl diethanolamide; coconut diethanolamide; fatty diethanolamide; lauramide dealauryl diethanolamide; PEG-6 lauramide; lauryl/myristyl monoethanolamide; oleic diethanolamide; alkyl ether phosphate; glycerol monooleate; polyglyceryl-10 decaoleate; polyglycerol esters; polyglycerol polyricinoleate; caprylic/capric triglyceride; caprylic triglyceride; tridecyl alcohol phosphate ester; nonylphenol ethoxylate phosphate ester; cetyl palmitate; butoxy ethyl stearate; butyl stearate; methyl laurate; methyl palmitate/oleate; PEG-2 stearate; glyceryl oleate; glyceryl stearate; isopropyl myristate; isopropyl palmitate; ethylhexyl isononanoate; PEG-4 dioleate; PEG-8 dilaurate; PEG-8 dioleate; PEG-8 distearate; PEG-8 laurate; PEG-8 oleate; PEG-8 stearate; PEG-12 dilaurate; PEG-12 dioleate; PEG-12 distearate; PEG-12 laurate; PEG-150 distearate; PEG-150 stearate; propylene glycol stearate; nonylphenol POE 10 phosphate ester; nonylphenol POE 6 phosphate ester; nonylphenol POE 8 phosphate ester; nonylphenol POE-12 phosphate ester; soybean oil, methyl ester; fatty alkyl ethoxylate; fatty alcohol ethoxylate; fatty acid ethoxylate; alcohol ethoxylate; tallow amine ethoxylate, POE-2; octyl phenol 12 mole ethoxylate; nonyl phenol 1.5 mole ethoxylate; nonyl phenol 4 mole ethoxylate; nonyl phenol 6 mole ethoxylate; nonyl phenol 9 mole ethoxylate; nonyl phenol 10 mole ethoxylate; nonyl phenol 10.5 mole ethoxylate; nonyl phenol 12 mole ethoxylate; nonyl phenol 15 mole ethoxylate; nonyl phenol 30 mole ethoxylate; nonyl phenol 40 mole ethoxylate; castor oil ethoxylate; castor oil 40 mole ethoxylate; octyl phenol 5 mole ethoxylate; octyl phenol 7 mole ethoxylate; octyl phenol 9 mole ethoxylate; octyl phenol 12 mole ethoxylate; octyl phenol 40 mole ethoxylate; octyl phenol ethoxylate; decyl alcohol ethoxylate, POE-4; decyl alcohol ethoxylate, POE-6; decyl alcohol ethoxylate, POE-9; tridecyl alcohol ethoxylate; tridecyl alcohol ethoxylate, POE-12; tridecyl alcohol ethoxylate, POE-18; tridecyl alcohol ethoxylate, POE-3; tridecyl alcohol ethoxylate, POE-6; tristyrylphenol ethoxylate; fatty acid ethoxylate, POE-3; fatty acid ethoxylate, POE-10; fatty acid ethoxylate, POE-15; octylphenol ethoxylate, 30 EO; octylphenol ethoxylate, 40 EO; tristyrylphenol ethoxylate POE-16 phosphate ester; ethoxylated coco amine; sorbital trioleate ethoxylate, POE 20; sorbital monooleate ethoxylate, POE 20; tallow amine ethoxylate, POE-IS; tallow amine ethoxylate, POE-2; or tallow amine ethoxylate, POE-5.

In one embodiment of the present invention, after the dispersion is inverted, at least one of the surfactants or a portion of the excess surfactant is reacted with an acid. According to the present invention, the acidified surfactant or the acidified portion of the excess surfactant returns to its pre-neutralization form and no longer function as a surfactant or it becomes hydrophobic and no longer has the structural capacity to function as a surfactant. In some embodiments, the ionic surfactant is inactivated as a surfactant when it is acidified by the acid. This overall reduction in the surfactant concentration in the dispersion may reduce the impact of the surfactant on the adhesive properties of the adhesive such as cohesive strength. In some embodiments, the inactivated surfactant is also a tackifier that remains in the dispersion to provide adhesive properties as a tackifier in the resulting adhesive formulation. For example, in embodiments where a rosin acid such as wood rosin is used as the surfactant, the wood rosin is acidified by the acid and no longer functions as a surfactant that impacts cohesive strength, but it remains in the dispersion and acts as a tackifier in the adhesive.

Any water soluble acid is suitable for use according to the present invention. Suitably, the acid should be of sufficient strength to react with the desired surfactant or a portion of the excess surfactant. Also, sufficient acid should be added to acidify the desired surfactant or to acidify the excess portion of the surfactant. In one embodiment, the acid reacts with at least one of the neutralized surfactants. Examples of suitable acids include, but are not limited to, phosphoric acid, acetic acid, sulfuric acid, or hydrochloric acid. In one embodiment, the acid is added until the pH drops from about 8.0-10.0 to about 5.5-7.5 which indicates that sufficient acid has been added to acidify a portion of the excess surfactant. Without being bound by any theory, in this process, the acid reacts with the neutralized surfactant to produce an organic species with significantly reduced amphiphilic character. Those molecules then reside in the organic phase of the resin particle. In some embodiments, if the neutralized surfactant that has been reacted with the acid is itself a tackifier, then that species will act as a tackifier in the final adhesive formulation.

For example, in one embodiment of the present invention, the following surfactant system would be suitable: about 25% to about 75% by weight of wood rosin based on the total weight of the resinous material in combination with about 25% to about 75% by weight of nonylphenol ethoxylate phosphate. In this embodiment, the dispersion is formed by neutralizing the wood rosin with potassium hydroxide in situ, i.e. in the presence of the molten resin to be dispersed. Acidification of the potassium rosinate may be accomplished by either addition of dilute acid to the dispersion following the inversion from a water in oil dispersion to an oil in water dispersion or in a more concentrated from at the end of the resin dispersion formation process.

Any conventional method for producing dispersions may be used according the present invention. In general, to produce the dispersion, the resinous material is contacted with one or more surfactants and water by any method known in the art. In one embodiment, the resin dispersion may be produced by a batch inversion process. In another embodiment, they may be produced using a continuous process.

Suitably, the surfactants are added so as to be present in the resin dispersion in an amount from about 2% to about 15% by weight, based on the weight of resinous material, for example from about 5% to about 10% by weight. Sufficient hot water, suitably from about 5% to about 15% by weight, based on the weight of resinous material, is stirred in to form a creamy water-in-oil emulsion. Upon dilution with water, suitably in an amount of from about 10% to about 35% by weight, based on the weight of resinous material, for example from about 15% to about 30% by weight, or from about 20% to about 25% by weight, the emulsion inverts to provide a stable oil-in-water emulsion. In some embodiments of the invention, concentrated acid is added to a pre-formed resin dispersion at this point in the process. The dispersion is suitably further diluted with water until the desired solids content is reached.

Once acidified, at least one of the surfactants in the inventive surfactant system is returned to its non-neutralized form or to its original hydrophobic form and no longer has the structural capacity to serve as a surfactant. Typically, the acidified surfactant is initially required to form the dispersion, but it is not needed to maintain the stability of the dispersion. The remaining surfactant(s) should be chosen such that under the conditions of neutralization of the first compound, it does not participate in reaction with the acid. The compound to be formed into a surfactant by reaction with base and later returned to its original form by reaction with acid can be about 5% to about 80% by weight based on the total solids of the material which is used to initially form the surfactant for inversion. The acid can be any type of water soluble acid with the condition that it is of sufficient strength to react with the desired surfactant in the inventive surfactant system.

In a further step, water may be slowly added to the resin tackifier mixture under agitation until phase inversion is reached. In one embodiment, the resulting emulsion is further diluted to the desired total solid content. The resulting dispersion is then slowly cooled under gentle agitation.

The amount of surfactant added to the resinous material is suitably between about 4 to about 9 parts, such as, for example, from about 5 to about 8 parts, per 100 parts tackifier, respectively (in parts per weight). The amount of neutralizing agent added is adjusted in a manner so that the final dispersions have pH values ranging from about 4 to about 12 or from about 6 to about 10.

The average particle size of the tackifiers in the tackifier dispersions as discussed above is suitably less than about 10 μm. For example, the average particle size of the tackifier is less than about 2 μm or less than about 1 μm, or even less than about 500 nm. In another embodiment, the average particle size of the tackifiers is less than about 250 nm. Generally, particle sizes and particle size distributions are measured with (laser) light scattering methods.

In a further embodiment, the resin dispersions have a Brookfield viscosity of less than about 6000 cPs or less than about 4000 cPs. Generally, viscosities are measured with a Brookfield LVT Viscometer. Surfactants with higher viscosities are covered by the present invention as long as the foam behavior is acceptable and the solid content is within the specified ranges.

For example, the viscosity of the tackifier dispersion is suitably adapted to the specific use but is suitably, measured as Brookfield (spindle 4@60 rpm) at 20° C., from about 100 to about 6000 cPs, for example from about 500 to about 5000 cPs, or from about 1000 to about 4000 cPs.

The solids content, i.e. the dry content of resinous material and surfactants, in the tackifier dispersion is suitably at least about 20% by weight up to the maximum content achievable such as, for example, from about 50% to about 70% by weight, or even from about 55% to about 65% by weight.

The tackifier dispersions according to the invention typically have a storage stability (shelf life) of at least about one year and will suitably demonstrate no substantial separation, coagulation or deposition. It is also preferred that the dispersions are low foaming and have good mechanical stability during pumping, transportation and mixing, as well as low foaming and good stability when formulated in adhesive compositions and during coating of the adhesive compositions.

In another aspect of the present invention, the resin dispersions produced according to the present invention can be used to prepare adhesive compositions. The inventive resin dispersions according to the present invention result in improved cohesion and adhesion properties of water-based adhesives prepared with said tackifier dispersions. For example, such adhesives can be advantageously used in the labeling and packaging industries, for any type of water-based tapes, road markings and flooring applications. In the aforementioned applications, the adhesives are pressure-sensitive. Other applications, in which the adhesive is not pressure sensitive, are included as well. Such applications include, but are not limited to barrier coatings or sealants.

According to the present invention, the adhesive formulation comprises at least one inventive tackifier dispersion as described above and at least one polymer component. In general, the polymer component may be a polymer dispersion or a latex emulsion. Accordingly, the terms latex, polymer latex, acrylic latex, polymer dispersion, emulsion polymer, polymer emulsion, or latex emulsion may be used interchangeably when describing the polymer component of the adhesive formulations. For example, the polymer component is an elastomeric polymer including elastomeric latexes, such as acrylics or styrene-butadiene rubber. Other polymers suitable for use with the tackifier dispersions according to the present invention include but are not limited to:
suspensions of natural rubber,
acrylic polymers derived from 2-ethylhexyl acrylate, butyl acrylate, methyl methacrylate, methacylic acid, and acrylic acid or mixtures thereof,
styrene-butadiene copolymers,
polymers derived from vinyl acetate, such as ethylene vinyl acetate,
poly chloroprene, or
acrylonitrile-butadiene copolymers.

Any mixture of two or more of these polymers could suitably be used as well.

In another embodiment of this invention, a process is provided to produce the adhesive composition. The process comprising contacting at least one tackifier resin dispersion, and at least one polymer latex. The contacting can be conducted by any method known in the art.

In one embodiment of the present invention, in order to prepare the inventive wet adhesive formulation (i.e. water-based), a tackifier dispersion according to the present invention and a polymer latex may be blended. Generally, the adhesive formulation consists of about 10% to about 60% of tackifier, such as for example about 20% to about 40% (based on dry weight).

The invention further relates to an aqueous adhesive composition comprising one or more polymers and the tackifier dispersion according to the invention. In one embodiment, the aqueous adhesive compositions are pressure sensitive adhesive (PSA) compositions. The aqueous adhesive composition suitably comprises from about 40 to about 90 weight % of a synthetic polymer latex or natural rubber latex, and from about 10 to about 60 weight % of the tackifier dispersion.

Suitable polymers in the aqueous adhesive composition are natural and synthetic rubbers such as polychloroprene rubber, styrene-butadiene rubbers, SIS block copolymers, SBS block copolymers, VAE (vinylacetate ethylene copolymers), nitrile rubbers and polyisobutylene rubbers, acrylate polymers, acrylic polymers such as acrylic esters and methacrylate polymers or mixtures thereof. Preferred polymers used in the aqueous adhesive composition according to the invention are acrylic polymers and/or acrylic ester copolymers. Other compounds known to the person skilled in the art may also be included in the aqueous adhesive composition exemplified by wetting agents, biocides, plasticizers, stabilizers, antioxidants, fillers, coloring agent and the like. The amounts of polymers/copolymers and other compounds contained in the adhesive compositions are not critical and may vary so as to give the preferred properties of the adhesive composition. The compounds can be in any physical state guided by the state of the adhesive composition such as dispersed in an aqueous phase, liquid or solid. Various additives can be added to the adhesive composition to give desired properties or for preventing degradation, or for any other purpose. Such additives include, but are not limited to, stabilizers, biocides, reinforcing agents, fire retardants, foaming agents, conventional tackifiers, plasticizers, oils, antioxidants, polymers, curable/reactive monomers, crosslinking agents, fillers, dyes, pigments, and wetting agents. Because of the number of possible compounding ingredients, the properties of the adhesive composition prepared according to this invention can be varied to satisfy most foreseeable requirements for tack, peel strength, shear strength, and solvent media resistant, on whatever combination of substrate is utilized.

In one embodiment of the present invention, the adhesive compositions can be applied to a substrate by being coated onto the surface of the substrate and then contacted with another surface which is a second substrate or second surface of the same substrate. Suitable substrates include, but are not limited to, plastic, paper, corrugated board, chip board, cardstock films, and filmic materials. Conventional coating methods including, but not limited to, gravure, reverse gravure, slot dye or rod coating may be used according to the present invention.

In a further aspect, the present invention is directed to a pressure sensitive adhesive overlay, prepared by applying a layer of a disclosed adhesive composition to a surface of a substrate, serving as an adhesive carrier, and drying the layer. As used herein, the term “overlay” refers to any substrate having a layer of adhesive material applied to at least a portion of its surface (“first surface”) and, thereby, adapted to be adhesively applied to a surface of another substrate (“second surface”) by bringing the first and second surfaces into contact under pressure.

In one embodiment of the present invention, the adhesive formulations can be waterborne adhesives used for the manufacture of pressure sensitive adhesives for adhesive overlays such as labels, tapes, decorative appliques, and the like. Suitable substrates serving as adhesive carriers may be prepared using non-woven material such as, for example, paper, plastic, metal or foam; or may be prepared using woven material, such as, for example, woven cotton or woven synthetic polymers. Some examples of the latter are polyethylene, polypropylene, polyvinyl chloride, polyester, and polyamide.

One embodiment of the present invention pertains to an adhesive composition comprising a tackifier resin dispersion, a polymer latex, and water, wherein the dispersion is prepared by a process comprising dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

Another embodiment of the present invention pertains to an adhesive composition comprising a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess rosin acid no longer migrates into the aqueous phase.

Another embodiment of the present invention pertains to a pressure sensitive adhesive overlay prepared by applying a layer of adhesive composition to a surface of a substrate, and drying the layer, wherein the adhesive composition comprises a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess portion of the rosin acid no longer migrates into the aqueous phase.

A further embodiment of the present invention pertains to a pressure sensitive adhesive overlay prepared by applying a layer of adhesive composition to a surface of a substrate, and drying the layer, wherein the adhesive composition comprises a tackifier resin dispersion, a polymer latex, and water, wherein the dispersion is prepared by a process comprising dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

This invention can be further illustrated by the following examples of potential embodiments thereof, although it will be understood that these examples are included merely for the purposes of illustration and are not intended to limit the scope of the invention unless otherwise specifically indicated. Parts and percentages mean parts by weight and percentages by weight, unless otherwise specified.

### EXAMPLES

In the examples, the dispersions were characterized in terms of total solids, particle size, viscosity, and pH. The total solids of the resin dispersions were determined using a microwave (CEM Labwave-9000 moisture solids analyzer).

The viscosity of the resin dispersions were measured using a Brookfield viscosity apparatus equipped with spindle number four at 60 RPM. Particle size was measured using a Microtrac UPA 150 laser diffraction instrument.

### Example 1

### Resin Dispersion Preparation (Acid Post-Addition Method)

A 1 L reaction vessel made of glass, heated with a heating mantle and equipped with a high torque stainless steel stirrer and thermocouple was used for the emulsification experiments. 225 g of a hydrocarbon resin and 75 g of a rosin ester were melted in the vessel at about 120° C. Once a homogeneous resin melt was obtained, the mass was cooled to 95° C. and 10.95 g of nonylphenol ethoxylate phosphate and 10.95 g of wood rosin were added to the reactor and mixed in at low mixing speeds. The mixture was neutralized with 6.9 g of a solution of 45% potassium hydroxide (KOH) and stirred until a homogenous mixture was obtained.

The temperature was further reduced to 90° C. with moderate stirring.

Demineralized water was preheated on a hot plate and added dropwise to the resin mixture. During the addition of water, a viscosity increase was observed. At a certain amount of water, the dispersion inverts from a water-in-oil to an oil-in-water dispersion. Beyond the inversion point the viscosity decreased again and the remainder of the water was added to the dispersion until a solids content of approximately 60% was obtained. The reactor was cooled down to below 40° C. and filtered through a stainless steel sieve with pore size of 180 μm.

The dispersion had the following physical properties: the total solids of the dispersion was 60.8%, the particle size 195 nm, pH 10.0, and viscosity 3980 cPs. A 100 g sample of the dispersion was placed into a jar. An agitator and pH probe were inserted into the jar and moderate stirring was applied. 1.57 g of a 25% (w/v) solution of acetic acid was added to the dispersion dropwise until the pH decreased to 6.5. Additional demineralized water was added until the total solids content was 56.7%.

### Example 2

### Resin Dispersion Preparation with Increased Nonylphenol Ethoxylate Phosphate to Wood Rosin Ratio

The same procedure was used as in Example 1 with the following exceptions: 16.5 g of nonylphenolethoxylate phosphate and 5.4 g of wood rosin.

The dispersion had the following physical properties: the total solids of the dispersion was 60.1% solids, particle size 296 nm, pH 9.5, and viscosity 4710 cPs. When 100 g of this dispersion was titrated with 1.23 g of 25% acetic acid, and additional demineralized water was added to achieve a total solids of 56.0%, the pH decreased to 6.6.

### Example 3

### Resin Dispersion Preparation (Resin Paste Dilution Method)

The reaction vessel made of stainless steel, heated with a hot plate and equipped with a high torque stainless steel stirrer was used for the emulsification experiments. If necessary, the temperature of the reaction mixture was recorded using a thermocouple. Approximately 100 g of a rosin ester was melted in the vessel to about 110° C. 4.5 grams of ethoxylated phosphate ester and 1.5 gram of stabelite resin E were then added to the vessel. The mixture was neutralized with 4 g of a solution of KOH (50% w/w) and stirred until a homogenous mixture was obtained. Stirring was then slowly increased and kept between 1200 and 2000 rpm. Demineralized water was preheated on a hot plate and added dropwise to the resin mixture. During the addition of water, a viscosity increase was observed. At a certain amount of water, the dispersion inverts from a water-in-oil to an oil-in-water dispersion. Beyond the inversion point the viscosity decreased again and a sample was taken from the reactor for pH measurements. The remainder of the water was acidified with phosphoric acid and added to the dispersion. The reactor was cooled down to room temperature at low stirring speeds and characterized. The dispersion had the following physical properties: the total solids of the dispersion was 53% and the particle size 180 nm. The pH of the sample taken from the reactor was 9.2 and the pH of the resin final product 6.0.

### Comparative Example

### Analogous Resin Dispersion without Removable Surfactant or Acidification

The same procedure was used as in Example 1 with the following exceptions: 21.9 g of nonylphenol ethoxylate phosphate and no wood rosin was used. The dispersion had the following physical properties: the total solids of the dispersion was 56.0% solids, pH 9.6, viscosity 3550 cPs and particle size 284 nm. The resin dispersion was not acidified.

Table I lists the results of the acid addition experiments. The results show that as the wood rosin concentration in the recipe is increased, the amount of acid necessary to reach a pH of 6.6 also increases indicating that the acid is selectively reacting with the wood rosin.

TABLE 1
Dispersion Acidification Results

| Sample | Comparative Example | Example 2 | Example. 1 |
|---|---|---|---|
| Ratio nonylphenolethoxylate | 100% nonylphenolethoxylate | 3:1 | 1:1 |
| phosphate to wood rosin | phosphate | | |
| Pre-acidification pH | 9.6 | 9.5 | 10.0 |
| Amount 25% acetic acid (g) | N/A | 1.23 | 1.57 |
| Post-acidification pH | N/A | 6.6 | 6.5 |

Resin dispersions produced according to the invention were used in adhesive formulations compounded using the recipes described in Table 2. Formulations were coated on a Flexcon 78BM 0-6 siliconized release paper and dried at 100° C. for 1 minute producing a dry film thickness of 21 g/m². Both 52 g/m² corona treated Mylar (polyester) and 78 g/m² Crown Label Y paper (Crown Van Gelder Papierfabrieken N.V.) was applied to the adhesive coated release paper. The constructions were conditioned for 1 day at 23° C. and 50% relative humidity prior to testing.

TABLE 2
Formulation for Adhesive Testing

| Component | Description | Amount (g) |
|---|---|---|
| Acronal V210 | Acrylic Latex | 100 |
| Ammonium Hydroxide, 28 wt % | Neutralent | 1.8 |
| Experimental Resin Dispersion | Tackifier Dispersion | 40.7 |
| Surfynol PSA336, 50 wt % | Wetting agent | 1.2 |
| Polyphobe 104, 20 wt % | Thickener | 0.0-1.0¹ |

¹Polyphobe 104 was added to achieve a formulation viscosity >2500 cPs needed to obtain homogeneous films when cast on siliconized release paper.

The following test method was utilized in the examples.
178° Shear (PSTC-107):

Five label specimens were cut into ¾″×¾″ strips. A ¾″×¾″ square of the adhesive specimen was centered onto a stainless steel panel and two passes were done using a 4.5 lb roller. A clamp was placed on the free end of the specimen ensuring that the clamp extended completely across the width and was properly aligned to distribute the load uniformly. The specimen was then placed in the test stand and a 1000 g mass was applied to the clamp. The time elapsed in which the specimen completely separated from the test panel was recorded. The values as listed in Table 3 are an average of five tests. The data shows that above a threshold level, as the amount of fugitive surfactant in the dispersion is reduced, the cohesive strength of the subsequent formulated adhesive increases.

TABLE 3
Cohesive Strength of Adhesive Formulations from Table 2

| Resin Dispersion in Adhesive | Comparative Example | Example 2 | Example 1 |
|---|---|---|---|
| Ratio nonylphenolethoxylate | 100% nonylphenol | 3:1 | 1:1 |
| phosphate to wood rosin | ethoxylate phosphate | | |
| 178° Shear (hr) | 8 | 3 | 14 |

The invention has been described in detail with particular reference to preferred embodiments thereof, but it will be understood that variations and modifications can be effected within the spirit and scope of the invention.

What is claimed is:

1. A process for producing a resin dispersion comprising:
(a) melting a resin;
(b) contacting the resin with a surfactant system comprising two or more surfactants;
(c) neutralizing at least one of the surfactants with at least one neutralizing agent;
(d) adding water to invert the dispersion; and
(e) adding an acid to react with at least one of the surfactants.

2. The process according to claim 1, wherein the acid reacts with at least one of the neutralized surfactants.

3. The process according to claim 1, wherein at least one of the surfactants is ionic.

4. The process according to claim 1, wherein two or more the surfactants are ionic.

5. The process according to claim 1, wherein at least one surfactant is ionic and at least one surfactant is nonionic.

6. The process according to claim 5, wherein the ionic surfactant is neutralized by the neutralizing agent.

7. The process according to claim 5, wherein sufficient acid is added to acidify the neutralized form of the ionic surfactant.

8. The process according to claim 4, wherein the pKa value of at least one of the non-neutralized ionic surfactants is higher than the remaining surfactants.

9. The process according to claim 8, wherein the neutralized form of the ionic surfactant with the higher pKa value reacts first with the acid.

10. The process according to claim 3, 4, or 5, wherein the ionic surfactant is any carboxylic acid containing compound, any phosphoric acid containing compound, any sulfuric acid containing compound, any alkyl sulphonates, any fatty alcohol sulphate containing compounds, any sulfonic acid containing compound, any sulfonate succinic acid containing compound, any sulfosuccinic acid containing compound, or any sulfosuccinamic acid containing compound, or any disulfosuccinic acid containing compound.

11. The process according to claim 10, wherein the ionic surfactant is a carboxylic acid containing compound.

12. The process according to claim 10, wherein the ionic surfactant is any carboxylic acid containing compound, any phosphoric acid containing compound, or any sulfuric acid containing compound.

13. The process according to claim 1, wherein at least one of the neutralized surfactants reacts with the acid and the acidified surfactant returns to its original non-neutralized form or its original hydrophobic form and no longer has the structural capacity to serve as a surfactant.

14. The process according to any one of claims 3, 4, or 5, wherein the ionic surfactant is initially required to form the dispersion but is not needed to maintain the stability of the dispersion.

15. The process according to any one of claims 3, 4, or 5, wherein the ionic surfactant is a rosin acid, hydrogenated rosin acid, disproportionated rosin acid, or modified rosin acid.

16. The process according to any one of claims 3, 4, or 5, wherein the ionic surfactant is a rosin acid.

17. The process according to any one of claims 3, 4, or 5, wherein the ionic surfactant is a wood rosin.

18. The process according to claim 5, wherein the nonionic surfactant comprises a nonylphenol ethoxylate phosphate.

19. The process according to claim 5, wherein the nonionic surfactant is one or more of the following of any long chain ethyoxylate block copolymers, any hydroxyl terminal long chain ethoxylates, alcohol ethoxylates, alkyl ethoxylates, alkyl phenols, alkyl phenol ethoxylates, alkyl alcohol ethoxylates, alkyl sulphonates, fatty alcohol sulphates, alkyl phenol ethoxylate phosphates, or phosphate esters.

20. The process according to claim 18, wherein the nonylphenol is selected from the group consisting of 4-nonylphenol with a varied and undefined degree of branching in the attached alkyl group, alkylsulfonic acid, fatty acid, oxyethylated alkyphenol and derivatives, or mixtures thereof.

21. A process for producing a resin dispersion comprising:
(a) melting a resin;
(b) contacting the resin with at least one surfactant, wherein at least one surfactant is added in excess;
(c) neutralizing at least one surfactant with at least one neutralizing agent;
(d) adding water to invert the dispersion; and
(e) adding an acid to react with the excess surfactant.

22. The process according to claim 21, wherein the excess portion of the surfactant is acidified and the acidified portion of the excess surfactant returns to its original state and no longer functions as a surfactant.

23. The process according to claim 21, wherein sufficient acid is added to acidify the excess portion of the surfactant.

24. The process according to claim 21, wherein the at least one surfactant is ionic.

25. The process according to claim 24, wherein the ionic surfactant is one or more of any carboxylic acid containing compound, any phosphoric acid containing compound, any sulfuric acid containing compound, any alkyl sulphonates, any fatty alcohol sulphate containing compounds, any sulfonic acid containing compound, any sulfonate succinic acid containing compound, any sulfosuccinic acid containing compound, or any sulfosuccinamic acid containing compound, or any disulfosuccinic acid containing compound.

26. The process according to claim 21, wherein the excess surfactant is initially required to form the dispersion but is not needed to maintain the stability of the dispersion.

27. The process according to claim 21, wherein at least one surfactant is a rosin acid, a hydrogenated rosin acid, a disproportionated rosin acid, or a modified rosin acid.

28. The process according to claim 21, wherein at least one surfactant is a rosin acid.

29. The process according to claim 21, wherein at least one surfactant is a wood rosin.

30. The process according to claim 1 or 21, wherein the resin comprises one or more of the following: (1) natural and modified rosins and the hydrogenated derivatives thereof; (2) esters of natural and modified rosins and the hydrogenated derivatives thereof; (3) polyterpene resins and hydrogenated polyterpene resins; (4) aliphatic petroleum hydrocarbon resins and the hydrogenated derivatives thereof; (5) aromatic hydrocarbon resins and the hydrogenated derivatives thereof; or (6) alicyclic petroleum hydrocarbon resins and the hydrogenated derivatives thereof.

31. The process according to claim 1 or 21, wherein the resin is one or more of rosins, rosin derivatives, rosin esters, hydrogenated rosin esters, hydrocarbon resins, aliphatic resins, cycloaliphatic resins, aromatic hydrocarbon resins, mixed aliphatic-aromatic resins, polyterpenes, synthetic polyterpenes, natural terpenes, or aromatically modified terpene resins.

32. The process according to claim 1 or 21, wherein the acid is any water soluble acid.

33. The process according to claim 1 or 21, wherein the acid is one or more of phosphoric acid, acetic acid, sulfuric acid, or hydrochloric acid.

34. The process according to claim 1 or 21, wherein the amount of acid added is from about 5% to about 80% by weight based on the total weight of the surfactants.

35. The process according to claim 1 or 21, wherein the acid is of sufficient strength to react with at least one of the surfactants.

36. The process according to claim 1 or 21, wherein the neutralizing agent is an amine, an alkali metal hydroxide, or an alkaline earth metal hydroxide.

37. An adhesive made using a dispersion produced by the process of claim 1 or 21.

38. A pressure sensitive adhesive made using a dispersion produced by the process of claim 1 or 21.

39. The resin dispersion of claim 1.

40. The resin dispersion of claim 21.

41. An adhesive composition comprising a tackifier resin dispersion, a polymer latex, and water, wherein the dispersion is prepared by a process comprising-dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

42. An adhesive composition comprising a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess rosin acid no longer migrates into the aqueous phase.

43. An adhesive of claim 41 or 42, wherein the cohesive strength of the adhesive is improved.

44. An adhesive of claim 43, wherein the improvements in cohesive strength are demonstrated by shear testing.

45. A pressure sensitive adhesive overlay prepared by applying a layer of adhesive composition to a surface of a substrate, and drying the layer, wherein the adhesive composition comprises a tackifier resin dispersion, a polymer latex, and water, wherein the dispersion is prepared by a process comprising dispersing resinous material with an excess of rosin acid in an aqueous phase that contains a neutralizing agent such as an amine or an alkali metal hydroxide and introducing a sufficient amount of a water soluble acid to the dispersion to react with the excess portion of the neutralized rosin acid so that the excess portion of the rosin acid no longer migrates into the aqueous phase.

46. A pressure sensitive adhesive overlay prepared by applying a layer of adhesive composition to a surface of a substrate, and drying the layer, wherein the adhesive composition comprises a tackifier resin dispersion, a polymer latex, and water, wherein the dispersion is prepared by a process comprising-dispersing resinous material with a nonylphenol ethoxylate phosphate and a rosin acid in an aqueous phase that contains a neutralizing agent such as an amine or an alkali metal hydroxide and introducing a water soluble acid to the dispersion to react with the neutralized rosin acid so that its migration into the aqueous phase is reduced.

47. The pressure sensitive adhesive of claim 45 or 46, wherein the overlay has improved cohesive strength.

48. An adhesive composition comprising: a resin dispersion of claim 1; a polymer latex; and water.

49. An adhesive composition of claim 48, used for labels on any kind of surface, packaging applications, flooring adhesives, road markings or any type of water-based tapes, barrier coatings or sealants.
